(19) United States
(12) Patent Application Publication
(10) Pub. No.: US 2009/0027492 A1
(43) Pub. Date: Jan. 29, 2009

(54) ELECTRONIC ENDOSCOPE DEVICE

(75) Inventor: Haruhiko HIBI, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/178,038

(22) Filed: Jul. 23, 2008

(30) Foreign Application Priority Data
Jul. 24, 2007 (JP) 2007-191737

(51) Int. Cl. G09G 3/28

(52) U.S. Cl. 348/68

(57) ABSTRACT

There is provided an electronic endoscope device for use with an electronic endoscope. The electronic endoscope device is provided with a light source unit configured to supply illumination light to the electronic endoscope, and a processor unit configured to process an image signal provided by the electronic endoscope. In this configuration, only one unit of the light source unit and the processor unit is configured to be directly connectable with the electronic endoscope, and the other unit of the light source unit and the processor not directly connectable with the electronic endoscope is configured to be directly connectable with the one unit configured to be directly connectable with the electronic endoscope.

### BACKGROUND OF THE INVENTION

The present invention relates to an electronic endoscope device having a light source unit supplying light to an electronic endoscope and a processor unit processing an image signal outputted by the electronic endoscope.

In general, a medical electronic endoscope use is used together with a light source unit for supplying light to the electronic endoscope inserted in a body cavity of a subject. Light emitted by the light source unit transmits through the electronic endoscope and is emitted from a tip end of an insertion tube of the electronic endoscope to illuminate an illumination target near the tip end of the insertion tube in the body cavity.

More specifically, the electronic endoscope is provided with a light guide formed of an optical fiber bundle elongated from a proximal end to the tip end of the insertion tube. The light source unit is connected with the electronic endoscope so that illumination light from a light emission device, such as a xenon lamp, enters a proximal end of the light guide of the electronic endoscope. The light which entered the light guide reaches the tip end of the insertion tube through the light guide, and is emitted from the tip end of the insertion tube to illuminate the illumination target around the tip end of the insertion tube.

At a tip end portion of the insertion tube, a solid-state image sensing device is provided to obtain an image of the illumination target around the tip end of the insertion tube. The obtained image is outputted from the solid-state image sensing device as an image signal. A processor unit is used to process the image signal and to output the processed image signal or processed data to a monitor or a printer. More specifically, the processor unit has the function of processing the image signal from the solid-state image sensing device to convert the image signal into a video signal having a predetermined format (e.g., an NTSC format). The processor also has the function of executing image processing for adjusting brightness, contrast and white balance.

In each of Japanese Patent Provisional Publication No. 2002-291698A (hereafter, referred to as JP2002-291698A) and Japanese Examined Patent Application Publication No. HEI 8-24668 (hereafter, referred to as JP HEI 8-24668), an electronic endoscope device having a light source unit and a processor is disclosed. The electronic endoscope device disclosed in these publications is configured such that the light source unit and the processor unit are integrally provided in a single body case.

Japanese Patent Provisional Publication No. HEI 6-22907 (hereafter, referred to as JP HEI 6-22907) discloses an electronic endoscope device having separate body cases respectively provided for a light source unit and a processor unit. In the system of JP HEI 6-22907, the electronic endoscope is directly connected to each of the body case of the light source unit and the body case of the processor unit.

In order to subject the electronic endoscope to disinfection, for example, by autoclaving or fumigation after use of the electronic endoscope, the electronic endoscope is disconnected from the processor unit and the light source (or from the body case in which the processor unit and the light source unit are integrally provided).

The electronic endoscope device disclosed in JP2002-291698A has an advantage that a user is only required to connect the electronic endoscope to a single connector provided on the body case accommodating both of the light source unit and the processor unit. However, because of the constraint that the light source unit and the processor unit are accommodated in a single body case, the electronic endoscope device disclosed in JP2002-291698A has a drawback that the number of production models is limited. That is, the user is not able to configure a suitably combined electronic endoscope device by selecting a desirable model of a light source unit and a desirable model of a processor unit in accordance with a budget and the user's own application.

Regarding the electronic endoscope device disclosed in JP HEI 6-22907, the user is able to select a desirable model of a light source unit and a desirable model of a processor unit in accordance with a budget and the user's own application because a light source unit and a processor unit are provided as separate units. However, the electronic endoscope device disclosed in JP HEI 6-22907 has a drawback that the user needs connect the electronic endoscope to both of the light source unit and the processor unit. Such a configuration may complicate work for setting up the electronic endoscope device.

### SUMMARY OF THE INVENTION

The present invention is advantageous in that it provides an electronic endoscope system which achieves easy attaching and detaching work for an electronic endoscope and enables a user to configure a suitable electronic endoscope device in accordance with a budget and the user's own application.

According to an aspect of the invention, there is provided an electronic endoscope device for use with an electronic endoscope. The electronic endoscope device is provided with a light source unit configured to supply illumination light to the electronic endoscope, and a processor unit configured to process an image signal provided by the electronic endoscope. In this configuration, only one unit of the light source unit and the processor unit is configured to be directly connectable with the electronic endoscope, and the other unit of the light source unit and the processor not directly connectable with the electronic endoscope is configured to be directly connectable with the one unit configured to be directly connectable with the electronic endoscope.

Such a configuration achieves easy attaching and detaching work for an electronic endoscope, and enables a user to configure a suitably combined endoscope device in accordance with a budget and the user's own application.

In at least one aspect, the light source unit is configured to be directly connectable with the electronic endoscope, the processor is configured to be directly connectable with the light source unit, and the image signal outputted by the electronic endoscope is transmitted to the processor unit via the light source unit.

In at least one aspect, the light source unit includes a signal line on which the image signal from the electronic endoscope is transmitted for the processor unit, and a photocoupler located at a position along the signal line so that an electronic endoscope side end of the signal line is insulated form the processor unit.

In at least one aspect, the light source unit includes a conversion circuit that converts parallel image signals from the electronic endoscope into a serial image signal, and the serial image signal is transmitted on the signal line toward the processor.

According to another aspect of the invention, there is provided an electronic endoscope system which is provided with an electronic endoscope, a light source unit configured to supply illumination light to the electronic endoscope, a processor unit configured to process an image signal provided by the electronic endoscope. In this configuration, the light source unit and the processor unit are directly connectable with respect to each other, only one unit of the light source unit and the processor unit is configured to be directly connectable with the electronic endoscope, and the electronic endoscope is configured to utilize, through the one unit directly connectable with the electronic endoscope, functions of the other unit of the light source unit and the processor unit not directly connectable with the electronic endoscope.

Such a configuration achieves easy attaching and detaching work for an electronic endoscope, and enables a user to configure a suitably combined endoscope device in accordance with a budget and the user's own application.

### BRIEF DESCRIPTION OF THE ACCOMPANYING DRAWINGS

FIG. 1 is a perspective view illustrating an entire system configuration of an electronic endoscope system according to an embodiment of the invention.

FIG. 2 is a block diagram of the electronic endoscope system.

FIG. 3 is a front view of a light source unit and a processor unit forming an endoscope device.

FIG. 4 is a rear view of the light source unit and the processor unit.

### DETAILED DESCRIPTION OF THE EMBODIMENTS

Hereinafter, an embodiment according to the invention is described with reference to the accompanying drawings.

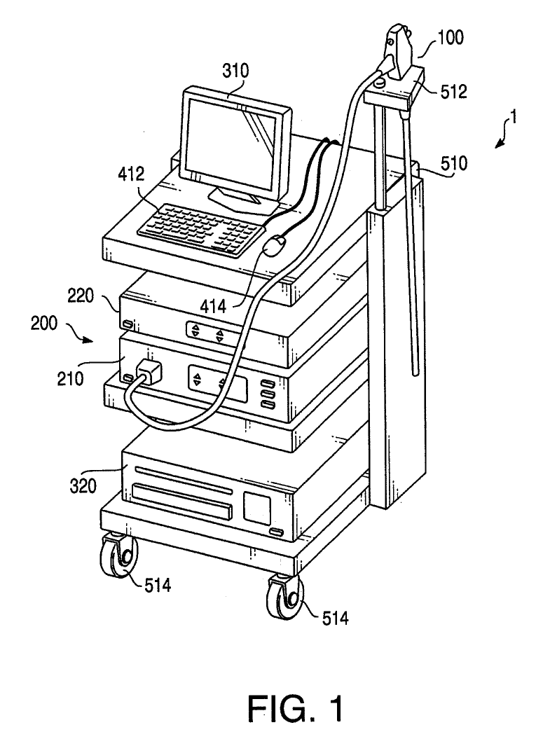

FIG. 1 is a perspective view illustrating an entire system configuration of an electronic endoscope system 1 according to an embodiment of the invention. As shown in FIG. 1, the electronic endoscope system 1 includes an electronic endoscope 100, an endoscope device 200, a monitor 310, a printer 320, a keyboard 412, and a mouse 414. The endoscope device 200, the monitor 310, the printer 320, the keyboard 412, the mouse 414 are accommodated in a rack 510. The rack 510 is provided with a hook 512 to which the electronic endoscope 100 can be hooked and casters 514 for moving the rack 510. With this configuration, it is possible to move freely the electronic endoscope system 1 in a situation where all of the units including the endoscope device 200 and the printer 320 are accommodated in the rack 510.

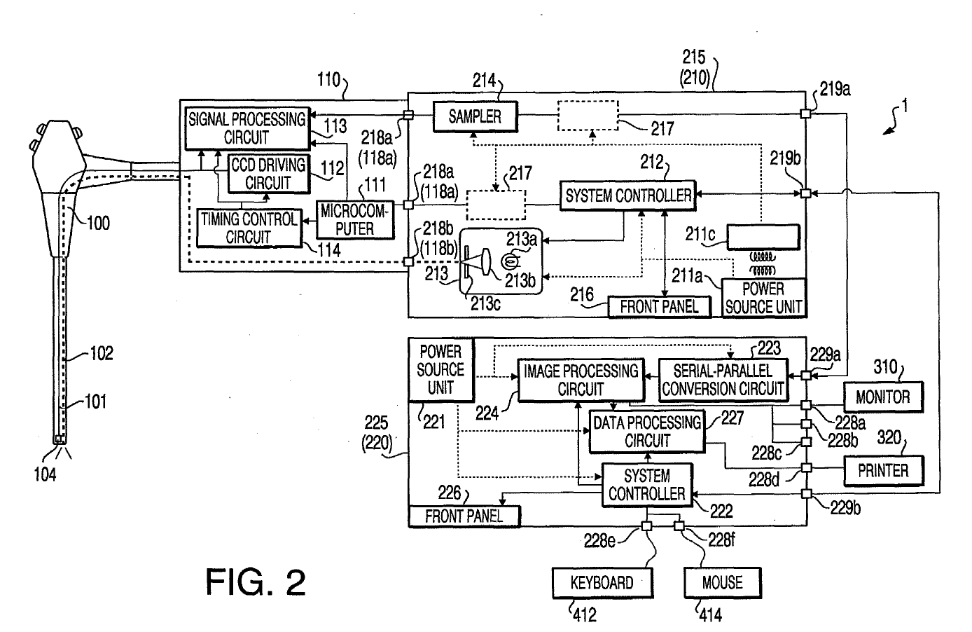

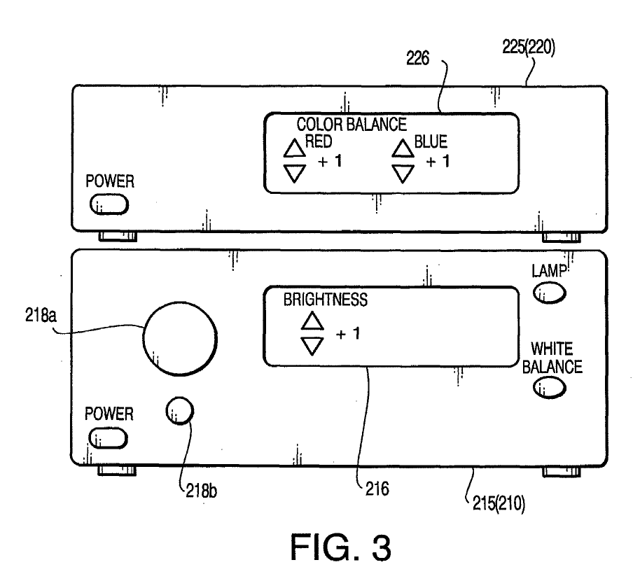

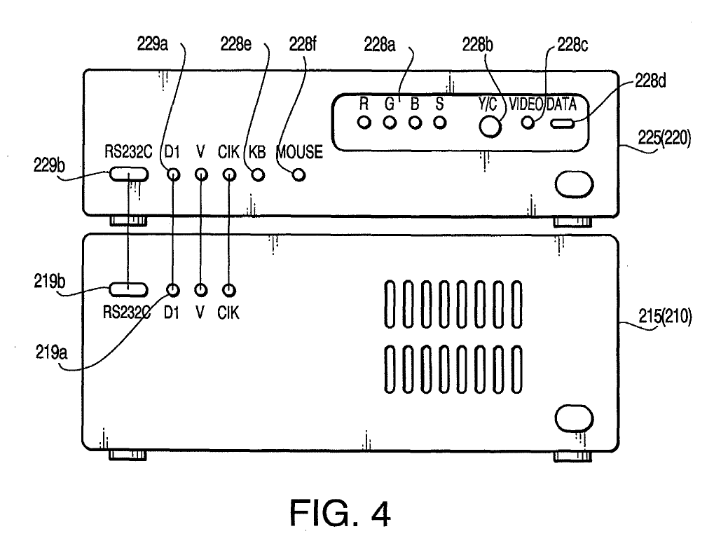

Details of the configuration of the electronic endoscope system 1 will now be explained. FIG. 2 is a block diagram of the electronic endoscope system 1. FIG. 3 is a front view of a light source unit 210 and a processor unit 220 forming the endoscope device 200. FIG. 4 is a rear view of the light source unit 210 and the processor unit 220.

As shown in FIG. 2, a connector unit 110 is provided at a proximal end of the electronic endoscope 100. In the connector unit 110, various types of electronic circuits are provided. More specifically, in the connector unit 110, a CCD driving circuit 112, a signal processing circuit 113, a timing control circuit 114 and a microcomputer 111 are provided. The CCD driving circuit 112 drives a CCD 104 provided at a tip end of an insertion tube 101 of the electronic endoscope 100. The signal processing circuit 113 processes an image signal outputted by the CCD 104. The timing control circuit 114 generates timing pulses for controlling operation timings of the CCD driving circuit 112 and the signal processing circuit 113 and transmits the timing pulses to the CCD driving circuit 112 and the signal processing circuit 113. The microcomputer 111 controls the signal processing circuit 113 and the timing control circuit 114.

The insertion tube 101 of the electronic endoscope 100 is provided with a light guide 102 elongated along the length of the insertion tube 101. An end of the light guide 102 is situated at the tip end of the insertion tube 101 and the other end of the light guide 102 is situated at a proximal end portion of the connector unit 110.

On a front panel of a case 215 of the light source unit 210, a signal connector 218a and a light guide connector 218b are located adjacently with respect to each other (see FIG. 3). The connector unit 110 is provided with a connector 118a and a connector 118b respectively corresponding to the signal connector 218a and the light guide connector 218b of the light source unit 210. In order to connect the connector unit 110 to the light source unit 210, the connector 118a and the connector 218a are respectively connected to the signal connector 218a and the light guide connector 218b of the light source unit 210.

In a state where the connector unit 110 has been connected to the light source unit 210, a proximal end (i.e., an incident facet) of the light guide 102 is situated inside of the case 215 of the light source unit 210. In this state, light emitted by a light emission device 213 of the light source unit 210 enters the incident facet of the light guide 102.

The light emission device 213 has a lamp 213a, a condenser lens 213b, and an aperture stop 213c. The light emitted from the lamp 213a enters a surface of the condenser lens 213b, and is converged by the condenser lens 213b toward the incident facet of the light guide 102. The aperture stop 213c is located between the condenser lens 213b and the incident facet of the light guide 102. The aperture stop 213c serves to change an open area ratio so that the light amount of light transmitted to the light guide 102 can be adjusted. The light source unit 210 is provided with a system controller 212 which controls an on/off state of the lamp 213a and the open area ratio of the aperture stop 213c.

As shown in FIG. 3, the light source unit 210 is provided with a front panel 216. Through the front panel 216, the user is able to control the on/off state of the lamp 213a and to adjust the light amount.

When the connector unit 110 is connected to the light source unit 210, a video signal from the signal processing circuit 113 of the electronic endoscope 100 is transmitted to a sampler 214 accommodated in the light source unit 210. The video signal from the signal processing circuit 113 is formed of a three-channel analog signal having an intensity signal and color-difference signals. The sampler 214 includes an A-D conversion circuit and a parallel-to-serial conversion circuit. The sampler 214 achieves the function of digitizing the analog signal from the signal processing circuit 113 and then multiplexing signals of the three-channel analog signal to generate and output a serial signal.

The serial signal thus outputted is transmitted to a video signal output terminal 219a through a photocoupler 217. The video signal output terminal 219a is located on an outer surface of a rear wall of the case 215 of the light source unit 210. The video signal output terminal 219a is connected to an video signal input terminal 229a provided on an outer surface of a rear wall of the case 225 of the processor unit 220 through a cable (see FIG. 4). In this configuration, the video signal processed by the light source unit 210 is transmitted to the processor unit 220. The processor unit 220 processes the video signal and outputs the processed video signal or the processed data to the monitor 310 or the printer 320.

Since the video signal is outputted from the sampler 214 to the processor unit 220 as a serial signal, the number of photocouplers for insulating the video signal can be decreased.

The video signal from the light source unit 210 is inputted to a serial-to-parallel conversion circuit 223 (see FIG. 2). The serial-to-parallel conversion circuit 223 converts the multiplexed video signal into three-channel parallel video signals in which an intensity signal and color-difference signals are separately included.

The parallel video signals are transmitted to an image processing circuit 224 in the processor unit 220. The image processing circuit 224 subjects an image obtained from the parallel video signals to predetermined image processing (e.g., adjustment of brightness, contrast and color balance) and converts the processed image into a video signal having a predetermined format (e.g., an RGB signal, a Y/C separation video signal and a composite video signal). The RGB signal, the Y/C separation signal and the composite video signal generated by the image processing circuit 224 are transmitted to an RGB terminal 228a, an Y/C separation video terminal 228b, and a composite video terminal 228c, respectively. The RGB terminal 228a, the Y/C separation video terminal 228b and the composite video terminal 228c are provided on an outer surface of the rear wall of the case 225 of the processor unit 220 (see FIG. 4). The monitor 310 is connected to one of the RGB terminal 228a, the Y/C separation video terminal 228b, and the composite video terminal 228c via a cable. With this configuration, an image picked up by the CCD 104 of the electronic endoscope 100 is displayed on the monitor 310. For example, in this embodiment, the monitor 310 is a monitor for a PC, and therefore is connected to the RGB terminal 228a.

The video signal processed by the image processing circuit 224 is also transmitted to a data processing circuit 227 (see FIG. 2). The data processing circuit 227 digitizes the video signal to form digital data having a predetermined format, and transmits the digital data to a data port 228d. For example, the printer 320 is connected to the data port 228d. The printer 320 prints out an image corresponding to the digital data. In this embodiment, a disk drive, such as a MO drive, can be connected to the data port 228d. Therefore, the user is able to store the digital data in a storage medium.

The image processing circuit 224 and the data processing circuit 227 are controlled by a system controller 222 of the processor unit 220. The system controller 222 is also connected to a front panel 226, a keyboard connector 228e and a mouse connector 228f. The front panel 226 is provided on an outer surface of the front wall of the case 225 of the processor unit 220 (see FIG. 3). The keyboard connector 228e and the mouse connector 228f are provided on an outer surface of the rear wall of the case 225 of the processor unit 220 (see FIG. 4). A keyboard 412 and a mouse 413 are connected to the processor unit 220 via the keyboard connector 228e and the mouse connector 228f, respectively.

The user is able to operate the processor unit 210 through the front panel 226, the keyboard 412 and the mouse 414. For example, through the front panel 226, the keyboard 412 and the mouse 414, the user is able to adjust an image from the electronic endoscope 100 or to transmit the image data corresponding to the image from the electronic endoscope 100 to the printer 320 or to the disk drive.

When the connector unit 110 of the electronic endoscope 100 is connected to the light source unit 210, the microcomputer 111 of the electronic endoscope 100 and the system controller 212 of the light source unit 210 are communicatably connected with each other via the photocoupler 217. In this configuration, the system controller 212 controls the microprocessor 111 of the electronic endoscope 100. The system controller 212 is able to obtain data from the microprocessor 111.

As shown in FIG. 4, a serial port 219b is provided on the outer surface of the rear wall of the case 215 of the light source unit 210, and a serial port 229b is provided on the outer surface of the rear wall of the case 225 of the processor unit 220. By connecting the serial ports 219b and 229b via a cable, the light source unit 210 and the processor unit 220 become able to transmit and receive information (e.g., a status of the light source unit) other than the video signal with respect to each other.

The light source unit 210 has a power source unit 211a which converts AC power supplied from a commercial power source into DC power. The DC power from the power source unit 211a is supplied to the system controller 212 and the light emission unit 213. There is a possibility that an output of the power source unit 211a exceeds the rated power due to, for example, an abnormal AC power level caused by lightning. In this regard, the electronic endoscope system 1 has the photocouplers 217 to separate signal lines so that an abnormal signal exceeding the rated power is not supplied to the electronic endoscope 100.

Each photocoupler 217 is configured to have a combination of a light emission device and a photoreceptor. The photocoupler 217 has a function of transmitting a signal while converting an electronic signal into an optical signal. Therefore, even if an abnormal voltage is applied to one end of the photocoupler 217, an abnormal voltage (or an abnormal current) is not transmitted to the other end of the photocoupler 217. In other words, the output of the photocoupler 217 does not exceed a power supply voltage for the photoreceptor. Consequently, circuits located on the side of the other end of the photocoupler 217 can be protected.

The light source unit 210 has circuits which needs to be located on the side of the electronic endoscope 100 with respect to the photocoupler 217 (e.g., the sampler 214 and the photocouplers 217 themselves). In order to prevent an abnormal voltage due to an abnormal state of the commercial power source from being supplied to the circuits which needs to be located on the side of the electronic endoscope 100 with respect to the photocoupler 217, the light source unit 210 is provided with an insulated power source 211c to supply power to such circuits (e.g., the sampler 214 and the photocouplers 217 themselves).

The insulated power source 211c obtains power from the power source unit 211a through a coil. That is, the insulated power source 211c is in non-contact with the power source unit 211a. Since the insulated power source 211c obtains power indirectly from the power source unit 211a via the coil, the output of the insulated power source 211c is defined to be within the rated power without exception regardless of the state of the input side of the insulated power source 211c (i.e., the sate of the output side of the power source unit 211a).

As described above, in this embodiment, the processor unit 220 and the light source unit 210 are provided as separate units. Further, the photocoupler 217 is provided between the connector 218a and the video signal output terminal 219a of the light source unit 210, and another photocoupler 217 is provided between the connector 218a and the serial port 219b. Therefore, even when an abnormal signal exceeding the rated power is inputted to the video signal output terminal 219a or the serial port 219b, the abnormal signal is prevented from being transmitted to the electronic endoscope 100. Therefore, there is no necessity to provide an insulated power source for the processor unit 220. That is, a normal type power source unit (221) can be used in the processor unit 220.

According to the above described embodiment, the electronic endoscope 100 is able to use, through the light source unit 210, the functions of the processor unit 220 regardless of the fact that the electronic endoscope 100 is not directly connected to the processor unit 220.

The above mentioned configuration of the electronic endoscope system 1 achieves easy attaching and detaching work for an electronic endoscope, and enables a user to configure a suitably combined endoscope device in accordance with a budget and the user's own application.

Although the present invention has been described in considerable detail with reference to certain preferred embodiments thereof, other embodiments are possible. In the above mentioned embodiment, the electronic endoscope system 1 is configured such that the electronic endoscope is directly connected to the light source unit, the electronic endoscope is not directly connected to the processor unit, and the light source unit and the processor unit are directly connected to each other. However, in another embodiment, an electronic endoscope system may be configured such that an electronic endoscope is directly connected to a processor unit, the electronic endoscope is not directly connected to a light source unit, and the processor unit and the light source unit are directly connected to each other.

This application claims priority of Japanese Patent Application No. P2007-191737, filed on Jul. 24, 2007. The entire subject matter of the application is incorporated herein by reference.

What is claimed is:

1. An electronic endoscope device for use with an electronic endoscope, comprising:
a light source unit configured to supply illumination light to the electronic endoscope; and
a processor unit configured to process an image signal provided by the electronic endoscope,
wherein:
only one unit of the light source unit and the processor unit is configured to be directly connectable with the electronic endoscope; and
the other unit of the light source unit and the processor not directly connectable with the electronic endoscope is configured to be directly connectable with the one unit configured to be directly connectable with the electronic endoscope.

2. The electronic endoscope device according to claim 1,
wherein:
the light source unit is configured to be directly connectable with the electronic endoscope;
the processor is configured to be directly connectable with the light source unit; and
the image signal outputted by the electronic endoscope is transmitted to the processor unit via the light source unit.

3. The electronic endoscope device according to claim 2,
wherein the light source unit comprises:
a signal line on which the image signal from the electronic endoscope is transmitted for the processor unit; and
a photocoupler located at a position along the signal line so that an electronic endoscope side end of the signal line is insulated form the processor unit.

4. The electronic endoscope device according to claim 3,
wherein:
the light source unit comprises a conversion circuit that converts parallel image signals from the electronic endoscope into a serial image signal; and
the serial image signal is transmitted on the signal line toward the processor.

5. An electronic endoscope system, comprising:
an electronic endoscope;
a light source unit configured to supply illumination light to the electronic endoscope;
a processor unit configured to process an image signal provided by the electronic endoscope;
wherein:
the light source unit and the processor unit are directly connectable with respect to each other;
only one unit of the light source unit and the processor unit is configured to be directly connectable with the electronic endoscope; and
the electronic endoscope is configured to utilize, through the one unit directly connectable with the electronic endoscope, functions of the other unit of the light source unit and the processor unit not directly connectable with the electronic endoscope.
